(19) United States
(12) Patent Application Publication
(10) Pub. No.: US 2005/0240989 A1
(43) Pub. Date: Oct. 27, 2005

(54) METHOD OF SHARING STATE BETWEEN STATEFUL INSPECTION FIREWALLS ON MEP NETWORK

(75) Inventors: Jin-Ho Kim, Seoul (KR); Sae-Woong Bahk, Seoul (KR); Hee-Jo Lee, Seoul (KR)

Correspondence Address: BLACKWELL SANDERS PEPER MARTIN LLP, 720 OLIVE STREET, SUITE 2400, ST. LOUIS, MO, 63101, US

(73) Assignee: SEOUL NATIONAL UNIVERSITY INDUSTRY FOUNDATION, Seoul (KR)

(21) Appl. No.: 10/709,255

(22) Filed: Apr. 23, 2004

(51) Int. Cl. H04L 9/00

(52) U.S. Cl. 726/11

(57) ABSTRACT

The present invention is devised to solve the problem in which a state cannot be kept track of because an outgoing traffic and an incoming traffic pass through different firewalls on a Multiple Entry/Exit Point (MEP) network having a plurality of entry points. In the present invention, firewalls physically remote from each other can share connection information using a modified SYN cookie, so that stateful inspection firewalls physically remote from each other can be used even on the MEP network.

### BACKGROUND OF INVENTION

1. Field of the Invention

The present invention relates generally to a method of sharing a state between stateful inspection firewalls on a multiple entry/exit point network and, more particularly, to a method of sharing a state between stateful inspection firewalls on a multiple entry/exit point network, which enables the state to be shared between the stateful inspection firewalls using a modified SYN cookie on the multiple entry/exit point network having a plurality of access points physically remote from each other.

2. Description of the Related Art

In general, a firewall is located at the boundary of a network, and functions to protect the network from the outside thereof. Recently, of various firewalls, a stateful inspection firewall is widely used. The stateful inspection firewall performs the function of a firewall in such a way as to intercept an incoming or outgoing packet, extract connection information, such as the source address, destination address, protocol, source port number and destination port number of the packet, from the packet, update a state table, and makes the determination of filtering based on the updated state table.

With reference to the accompanying drawings, the operation of a conventional stateful firewall 30 is described in detail below.

FIG. 1 is a system configuration diagram showing the operation of the conventional stateful inspection firewall 30.

As shown in FIG. 1, the stateful inspection firewall 30 is located between a client 10 and a server 20, and data are exchanged between the server 20 and the client 10 according to the Transmission Control Protocol (TCP). That is, data are exchanged between the server 20 and the client 10 according to the ‘3-way handshaking’ rule.

In accordance with the ‘3-way handshaking’ rule, there are performed the first step of the client 10 sending a SYN packet requesting an access to the server 20, the second step of the server 20 sending a SYN/ACK packet indicating the acceptance of the request to the client 10, and the third step of the client sending an ACK packet to the server 20, a connection being established between the server 20 and the client 10 and data being exchanged between the server 20 and the client 10.

FIG. 2 is a diagram showing the format of a TCP header.

A SYN packet, a SYN/ACK packet and an ACK packet are determined by the TCP header. With reference to FIG. 2, the SYN packet is determined when a SYN flag 50 is 1 and an ACK flag 52 is 0, the SYN/ACK packet is determined when the SYN flag 50 is 1 and the ACK flag 52 is 1, and the ACK packet is determined when the SYN flag 50 is 0 and the ACK flag 52 is 1. Furthermore, each of the packets includes a sequence number 54 and an acknowledgement number 56, in which the sequence number 54 of the SYN packet and the SYN/ACK packet becomes an Initial Sequence Number (ISN). The sequence number of the SYN packet, which the client 10 sends to the server 20 at the first step of the ‘3-way handshaking’ rule, becomes ISN_{c}, and the sequence number 54 of the SYN/ACK packet, which the server 20 sends to the client 10 at the second step thereof, becomes ISN_{S}. In the meantime, the acknowledgement number 56 becomes ISN_{c}+1 in the SYN/ACK packet that the server 20 sends to the client 10, and becomes ISNₛ+1 in the first ACK packet that the client 10 sends to the server 20.

In FIG. 1, when the client 10 sends the SYN packet to the server 20 while requesting an access to the server, the firewall 30 inspects the SYN packet, and passes the SYN packet therethrough if such a connection is set to be permitted. The firewall 30 should pass therethrough the SYN/ACK packet, which is sent from the server 20 to the client 10 in response to the SYN packet, as well as the SYN packet, which the client 10 sends while requesting the access to the server 20. This can be implemented by recording connection information in the state table of the firewall 30. The firewall 30 searches the connection information of the state table, and passes the packet therethrough if corresponding connection information exists.

FIG. 3 is a diagram showing the state table of the conventional firewall 30. In the state table t can be recorded connection information, including a source address t1, a destination address t2, a protocol t3, a source port number t4, a destination port number t5 and a connection state t6.

When the client 10 sends the SYN packet to the server 20 while requesting an access to the server 20, the firewall 30 extracts the source address t1, the destination address t2, the protocol t3, the source port number t4, and the destination port number t5 from the SYN packet, records the extracted information in the state table t, and records the connection state t6 as ‘SYN_SENT.’ Thereafter, when the SYN/ACK packet in response to the SYN packet arrives, the firewall 30 searches the state table t for connection information related to such a connection, and passes the SYN/ACK packet therethrough if the connection information exists. Subsequently, the firewall 30 changes the connection state t6 to ‘SYN_RECV’ because the firewall 30 has received the SYN/ACK packet, and then passes the SYN/ACK packet therethrough. In brief, the stateful inspection firewall 30 performs the function of a firewall by keeping track of the connection state t6 and recording it.

However, the conventional stateful inspection firewall is problematic in that it is only available on a network having a single entry point because all the incoming and outgoing traffics of a connection must be monitored to keep track of the connection state t6. That is, the conventional stateful inspection firewall 30 is operable only on a Single Entry Point (SEP) network, but is not operable on a MEP network having a plurality of entry points because an outgoing traffic and an incoming traffic may be passed through different firewalls, and thus it is difficult to keep track of the state.

### SUMMARY OF INVENTION

Accordingly, the present invention has been made keeping in mind the above problems occurring in the prior art, and an object of the present invention is to provide a method of sharing a state between stateful inspection firewalls on an MEP network, which enables the state to be shared between the stateful inspection firewalls physically remote from each other using a modified SYN cookie (hereinafter referred to as a “m.SYN cookie”) when data is exchanged according to the ‘3-way handshaking’ rule.

In order to accomplish the above object, the present invention provides a method of sharing a state between stateful firewalls on an MEP network for data exchange between a server and a client through firewalls physically remote from each other, comprising the steps of (a) one of the firewalls receiving a SYN packet sent from the client to the server; (b) the firewall creating an m.SYN cookie, modifying the SYN packet using the m.SYN cookie and sending the SYN packet to the server, and the server sending a SYN/ACK packet to the client in response to the SYN packet; (c) the firewall, which has received the SYN/ACK packet, extracting a firewall identifier ID_{fw} from the SYN/ACK packet and sending the SYN/ACK packet to a corresponding one of the firewalls, the corresponding firewall searching a state table for connection information and sending the connection information, together with the SYN/ACK packet, to the firewall, which has received the SYN/ACK packet; and (d) the firewall, which has re-received the SYN/ACK packet, updating the state table, changing an acknowledgement number of the SYN/ACK packet to an Initial Sequence Number (ISN_{c})+1, and sending the SYN/ACK packet to the client.

### BRIEF DESCRIPTION OF DRAWINGS

The above and other objects, features and advantages of the present invention will be more clearly understood from the following detailed description taken in conjunction with the accompanying drawings, in which:

FIG. 1 is a system configuration diagram showing the operation of a conventional stateful inspection firewall.

FIG. 2 is a diagram showing the format of a TCP header.

FIG. 3 is a diagram showing the state table of the conventional firewall.

FIG. 4 is a system configuration diagram illustrating a method of sharing a state between stateful inspection firewalls on an MEP network in accordance with the present invention.

FIG. 5 is a block diagram of a stateful inspection firewall in accordance with the present invention.

FIG. 6 is a flowchart showing the method of sharing the state between the stateful inspection firewalls on the MEP network.

FIG. 7 is a diagram showing an m.SYN cookie in accordance with the present invention.

FIG. 8 is a diagram showing the state table t of the stateful inspection firewall in accordance with the present invention.

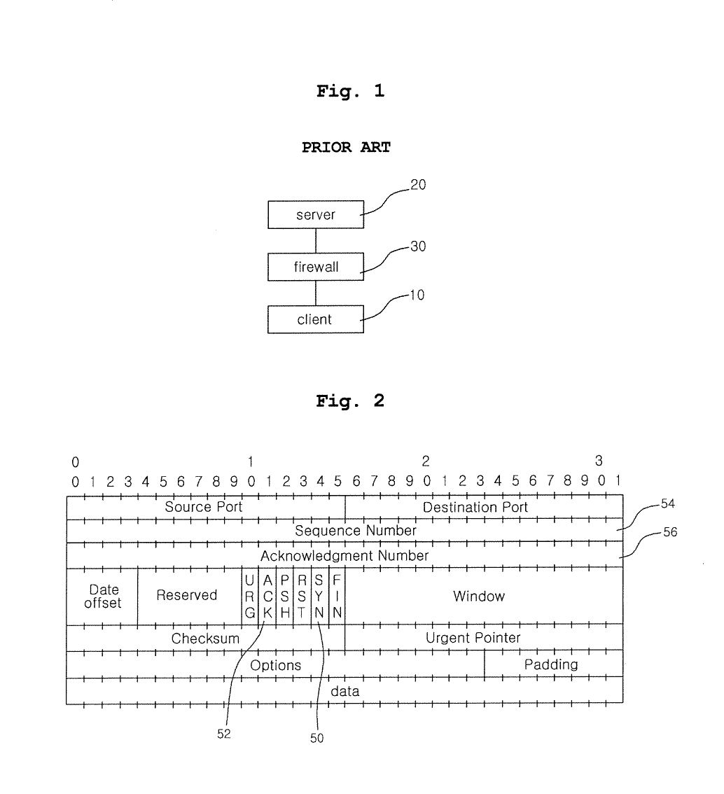

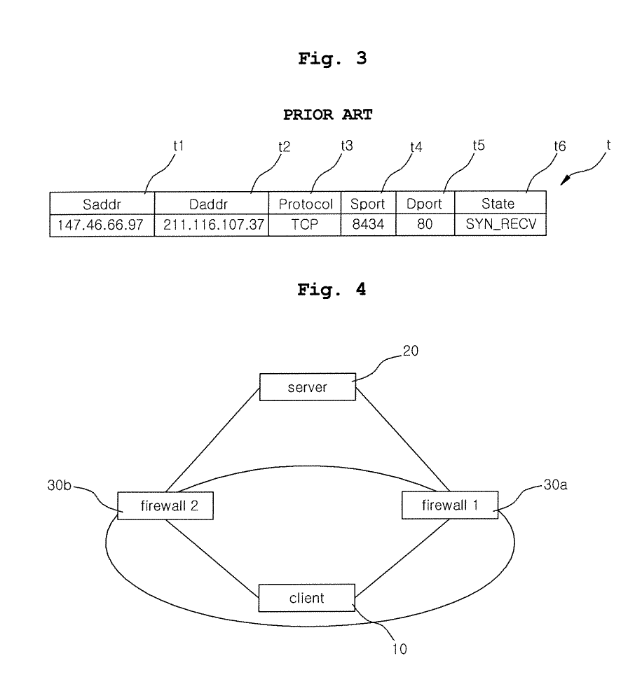

### DETAILED DESCRIPTION

Reference now should be made to the drawings, in which the same reference numerals are used throughout the different drawings to designate the same or similar components.

FIG. 4 is a system configuration diagram illustrating a method of sharing a state between stateful inspection firewalls on an MEP network in accordance with the present invention.

The MEP network, as shown in FIG. 4, includes a client 10, a server 20, and a firewall 130a and a firewall 230b that are physically remote from each other. In this case, the firewall 130a and the firewall 230b are installed to protect the network of the client 10 from the outside thereof. The firewall 130a and the firewall 230b are stateful inspection firewalls 30, which intercept exchanged packets, extract connection information from the intercepted packets, update internal state tables t, and make the determination of filtering based on the updated state tables t.

FIG. 4 depicts only a preferred embodiment of the present invention for an illustrative purpose. Although the method of sharing the state between the stateful inspection firewalls on the MEP network according to the present invention can be applied to the case where a client is located outside and a server is located inside, etc., the same inventive concept is employed, so that only the case of FIG. 4 is described in detail below.

In FIG. 4, in order to enable data to be exchanged between the client 10 and the server 20, a traffic outgoing from the network of the client 10 to the server 20 and a traffic incoming from the server 20 to the network of the client 10 should pass through the firewall 30. At this time, the case where the outgoing and incoming traffics pass through the same firewall does not matter. The case where the outgoing and incoming traffics pass through different firewalls (asymmetrical paths) requires the sharing of a state between the firewall 130a and the firewall 230b.

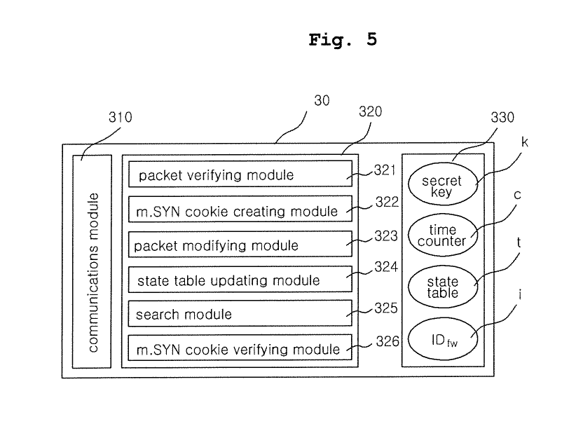

FIG. 5 is a block diagram of a stateful inspection firewall 30 in accordance with the present invention.

As shown in FIG. 5, the firewall 30 includes a communications module 310, a control module 320 and a database 330.

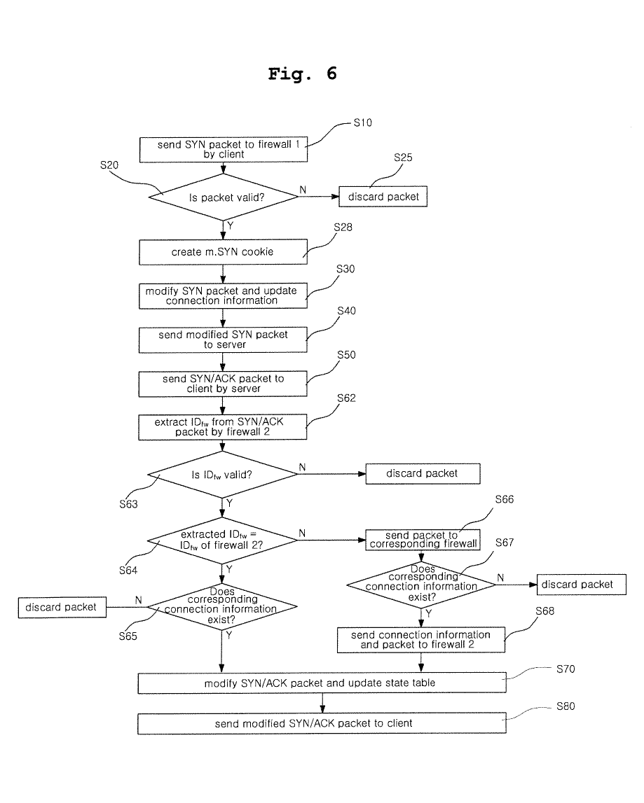

The communications module 310 functions to receive and send packets. The control module 320, as shown in FIGS. 5 and 6, functions to control the execution of processes related to the method of sharing a state between stateful inspection firewalls on an MEP network.

In more detail, the control module 320 includes a packet verifying module 321 verifying whether a received packet is valid or invalid according to a firewall rule set by an administrator, an m.SYN cookie creating module 322 creating an m.SYN cookie, a packet modifying module 323 modifying the packet according to a set process, a state table updating module 324 updating a state table t according to the set process, a search module 325 searching the state table t for connection information and searching information stored in the database 330, and an m.SYN cookie verifying module 326 verifying whether m.SYN cookie is valid.

The database 330 includes a firewall identifier (hereinafter referred to as a “ID_{fw}”) i, a state table t storing connection information, a time counter c, and a secret key k. The ID_{fw} i is a bit value identifying each of the firewalls included in the network, the state table t is the table in which the connection information of the firewall 30 is stored, and the time counter c is a bit counter that is included in the firewall 30 and increased at certain intervals. Furthermore, in the database 330 is included the secret key k unique to the network.

The method of sharing the state between stateful inspection firewalls 30 on the MEP network uses an m.SYN cookie to allow the state to be shared between the firewall 130a and the firewall 230b that are physically remote from each other when data are exchanged according to the ‘3-way handshaking’ rule. While it is assumed that the firewall creating the m.SYN cookie is set to the firewall 130a, the firewall verifying the m.SYN cookie is set to the firewall 230b and all the firewalls 30 share the synchronized time counter c increasing every 16 seconds, the method of sharing the state between the stateful inspection firewalls is described in detail below.

FIG. 6 is a flowchart showing the method of sharing the state between the stateful inspection firewalls 30 on the MEP network.

With reference to FIG. 6, the client 10 sends a SYN packet to the firewall 130a at step S10. The firewall 130a receives the SYN packet through the communications module 310, and the packet verifying module 321 verifies whether the SYN packet is valid according to a firewall rule set by an administrator at step S20. If, as a result of the verification, the SYN packet is not valid (‘N’ at step S20), and the SYN packet is discarded in the firewall 130a at step S25. If the SYN packet is valid (‘Y’ at step S20), the m.SYN cookie creating module 322 creates the m.SYN cookie at step S28.

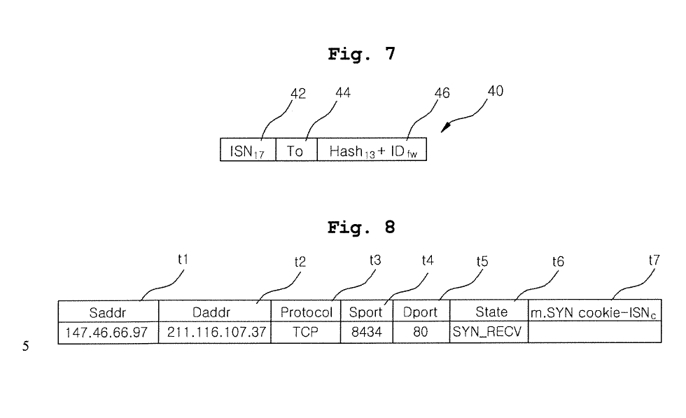

FIG. 7 is a diagram showing the m.SYN cookie 40 that is created in the m.SYN cookie creating module 322.

As shown in FIG. 7, the m.SYN cookie 40 includes ISN₁₇ 42, T₀ 44 and ‘Hash₁₃+ID_{fw}’ 46.

The ISN₁₇ 42 is determined by the upper 17 bit value of ISN of the SYN packet to support fast reincarnation.

In regard to the reincarnation of a TCP connection, there is the prescription “assigns its ISN for the new connection to be larger than the largest sequence number it used on the previous connection incarnation.”

In the present invention, the fast reincarnation of a TCP connection does not occur frequently. If the fast reincarnation occurs, it is assumed that ISN increases to be larger than SNprev (the largest sequence number it used on the pervious connection incarnation) by at least 32768.

In more detail, the fact that ISN is larger than SNprev by at least 32768 (2\hat{ }15) imports that the 16-th bit of a 32-bit binary number is larger by 1 in terms of a bit level. Consequently, in the host supporting fast reincarnation, the upper 17 bit value (ISN₁₇ 42) of the ISN of the SYN packet is larger than the upper 17 bit value of the SNprev by at least 1 on a bit level.

If the ISN fulfills the above-described preconditions, m.SYN cookie 40 is larger than SNprev even though any numerical value is inserted into the lower 15 bits in addition to ISN₁₇ 42. Accordingly, in the SYN packet in which the ISN has been replaced with the m.SYN cookie 40, the ISN is larger than the SNprev, so that the method of sharing the state between the stateful inspection firewalls 30 on the MEP network can support a host in which fast reincarnation occurs.

Furthermore, in the method of sharing the state between the stateful inspection firewalls 30 in accordance with the present invention, the firewalls 30, which are the subjects of the creation and verification of the m.SYN cookie 40, may be different from each other, so that T₀ 44 is included in the m.SYN cookie 40. The T₀ 44 is the least significant two bits of time_{org} time indicated by the time counter c when the firewall 130a creates the m.SYN cookie 40, and is defined by the following Equation 1. With the Equation 1, the firewall 230b accurately extracts the time when the m.SYN cookie 40 is created, and can use the extracted value as an input to a hash function inspecting whether the m.SYN cookie 40 is valid.
T₀=time_{org}mod4 (1)
where time_{org} is the time indicated by the time counter c org when the firewall 130a creates the m.SYN cookie 40, and mod4 is the remainder obtained through division by 4.

Furthermore, the m.SYN cookie 40 includes ‘Hash₁₃+ID_{fw}’ 46. In the present invention, Hash₁₃ is determined by the following Equation 2, and is 13 bits, unlike the fact that the output value of the hash function of a conventional SYN cookie is 32 bits.
Hash₁₃=Hash(k, sa, sp, da, dp, time_{org}, ISN_{c}>>15)%2\hat{ }13 (2)
where Hash( ) is the output value of a hash function, k is a secret key, sa is a source address t1, sp is a source port number t4, da is a destination address t2, dp is a destination port number t5, ISN_{c}>>15 is a value obtained by eliminating the lower 15 bits from ISN_{c}, and Hash( )%2\hat{ }13 is the value of the lower 13 bits of the output value of the hash function.

As shown in the Equation 2, in the present invention, Hash₁₃ is determined using the secret key k shared by the firewalls 30 as a variable of the hash function. Accordingly, only if the firewall 230b learns the secret key k, the firewall 230b can produce the same Hash at the time of verification. That is, the secret key k is used to prevent an attacker from counterfeiting the m.SYN cookie. Since attackers do not know the secret key k, most of the counterfeited m.SYN cookies are discarded during verification even though the attackers randomly produce the m.SYN cookies. Meanwhile, ‘Hash₁₃+ID_{fw}’ 46, which is the last 13 bits of the m.SYN cookie 40, is finally determined by adding the firewall identifier to the Hash₁₃.

Referring to FIG. 6 again, the m.SYN cookie creating module 322 of the firewall 130a creates the m.SYN cookie 40 including the above-described values at step S28. Thereafter, the packet modifying module 323 of the firewall 130a replaces the ISN_{c} of the received SYN packet with the m.SYN cookie 40, and the state table updating module 324 updates the connection information of the state table t (source address, source port number, destination address, destination port number, and the difference between the ISN_{c} and the m.SYN cookie) at step S30. In this case, the updated state table t is stored in the database 330.

FIG. 8 is a diagram showing the state table t of the stateful inspection firewall 30 in accordance with the present invention.

Referring to FIG. 8, the state table t includes ‘m.SYN cookie-ISN_{c}’ t7, in addition to the items of the conventional state table t. The ‘m.SYN cookie-ISN_{c}’ t7 functions to allow the firewall 230b to learn the value of the ISN_{c} even though the firewall 130a replaces the ISN_{c} of the SYN packet with the m.SYN cookie 40.

After the packet modifying module 323 of the firewall 130a replaces the ISN_{c} of the SYN packet with the m.SYN cookie 40 and the state table updating module 324 updates the connection information of the state table t of the firewall 130a at step S30, the modified SYN packet is sent to the server 20 through the communications module 310 at step S40. Subsequently, the server 20 sends a SYN/ACK packet to the client 10 in response to the SYN packet at step S50. At this time, the acknowledgement number 56 of the SYN/ACK packet becomes ‘m.SYN cookie+1.’

In the meantime, the SYN/ACK packet sent from the server 20 to the client 10 reaches the firewall 230b prior to reaching the client 10. When the communications module 310 of the firewall 230b receives the SYN/ACK packet, the m.SYN cookie verifying module 326 of the firewall 230b is activated. The m.SYN cookie verifying module 326 acquires the ID_{fw} from the m.SYN cookie 40, which is extracted from the acknowledgement number 56 of the SYN/ACK packet, through the use of the following Equation 3 at step S62.
ID_{fw}=(SC−Hash(k, sa, sp, da, dp, timeᵢₙₚᵤₜ, SC>>15))%2\hat{ }13 (3)
where SC is the m.SYN cookie 40 extracted from the acknowledgement number 56 of the SYN/ACK packet, SC>>15 is the value obtained by eliminating lower 15 bits from the SC, and ( )%2\hat{ }13 is the lower 13 bits of value of ( ).

In the Equation 3, timeᵢₙₚᵤₜ is obtained from the following input Equation 4.
timeᵢₙₚᵤₜ=time_{curr}+1−((time_{curr}+1(SC>>13))mod4)=time_{curr}+1−((time_{curr}+1−T₀)mod4) (4)
where time_{curr} is the time indicated by the time counter c of the firewall 230b at the time of verifying the m.SYN cookie, and SC>>13 is the value obtained by eliminating lower 13 bits from the SC.

The m.SYN cookie verifying module 326 extracts ID_{fw} using the Equations 3 and 4 at step S62, and verifies whether the extracted ID_{fw} is valid at step S63. In this case, if the extracted ID_{fw} does not fulfill “0≦ID_{fw}≦MAX_{id} (MAX_{id}: the greatest value of the ID_{fw}s of the firewalls)” (‘N’ Id fw at step 63), the m.SYN cookie 40 was counterfeited and the received packet is discarded. If the extracted ID_{fw} fulfills “0≦ID_{fw}≦MAX_{id}” (‘Y’ at step 63), the process proceeds to the next step.

If the extracted ID_{fw} is verified to be valid (‘Y’ at step S63), the m.SYN cookie verifying module 38 compares the extracted ID_{fw} with its own ID_{fw} at step S64. If, as a result of the comparison, the extracted ID_{fw} is identical with the ID_{fw} of the m.SYN cookie verifying module 38 (‘Y’ at step S64), the state table updating module 324 searches the state table t for connection information. If the connection information exists (‘Y’ at step S65), the state table updating module 324 updates the state table t to allow ‘SYN_RECV’ to be recorded in the connection state t6. The packet modifying module 36 changes the acknowledgement number 56 of the SYN/ACK packet to ‘ISN_{c}+1.’ In this case, the ISN_{c} is the value obtained by subtracting the ‘m.SYN cookie-ISN_{c}’ t7 from the m.SYN cookie 40, so that the firewall 230b can learn the ISN_{c} at step 570.

In the meantime, if the extracted ID_{fw} is different from the ID_{fw} of the firewall 230b (that is, asymmetrical paths), the communications module 310 sends the SYN/ACK packet to the firewall 130a corresponding to the extracted ID_{fw} at step S66.

The search module 325 of the firewall 130a having received the SYN/ACK packet searches the state table t for the connection information at step S67. If the connection information exists (‘Y’ at step S67), the search module 325 updates the connection state t6 of the state table t of the firewall 130a as ‘SYN_RECV’ and sends the connection information, together with the SYN/ACK packet, to the firewall 230b at step S68.

Thereafter, the state table updating module 324 of the firewall 230b updates the state table t so that ‘SYN_RECV’ is recorded in the connection state t6 of the state table t, and the packet modifying module 323 replaces the acknowledgement number 56 of the SYN/ACK packet with ‘ISN_{c}+1’ at step S70.

Thereafter, the modified SYN/ACK packet is sent to the client 10 through the communications module 310 of the firewall 230b at step S80, so that the connection information can be shared between the firewall 130a and the firewall 230b. With this, the following packets, including the next ACK packet, can be directly passed through the two firewalls without additional information exchange.

In the meanwhile, the method of sharing the state between the stateful inspection firewalls according to the present invention can be applied to the case where a firewall and a Network Address Translator are used together, and a File Transfer Protocol connection, besides the above-described embodiment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of sharing a state between stateful firewalls on a multiple entry/exit point (MEP) network for data exchange between a server and a client through firewalls physically remote from each other, comprising the steps of:
(a) one of the firewalls receiving an SYN packet sent from the client to the server;
(b) the firewall creating a modified SYN cookie (hereinafter referred to as an m.SYN cookie), modifying the SYN packet using the m.SYN cookie and sending the SYN packet to the server, and the server sending a SYN/ACK packet to the client in response to the SYN packet;
(c) the firewall, which has received the SYN/ACK packet, extracting a firewall identifier ID_{fw} from the SYN/ACK packet and sending the SYN/ACK packet to a corresponding one of the firewalls, the corresponding firewall searching a state table for connection information and sending the connection information, together with the SYN/ACK packet, to the firewall, which has received the SYN/ACK packet; and
(d) the firewall, which has re-received the SYN/ACK packet, updating the state table, changing an acknowledgement number of the SYN/ACK packet to an Initial Sequence Number (ISN_{c})+1, and sending the SYN/ACK packet to the client.

2. The method as set forth in claim 1, wherein the firewalls share a synchronized time counter, which is increased at regular intervals, and a same secret key.

3. The method as set forth in claim 1, wherein the state table includes a difference between the ISN and the m.SYN cookie, and connection information, including a source address, a destination address, a protocol, a source port and a destination port number of the packet.

4. The method as set forth in claim 1, where step (a) further comprises the step of:
the firewall, which has received the SYN packet, inspecting the SYN packet according to a preset firewall rule, and performing step (b) if a current connection is a permitted connection, or discarding the SYN packet if the current connection is not the permitted connection.

5. The method as set forth in claim 2, wherein the m.SYN cookie includes upper bits of the ISN of the SYN packet, bits of time indicated by the time counter of the firewall, which creates the m.SYN cookie, at a time of creation of the m.SYN cookie, and bits of an output value of a hash function.

6. The method as set forth in claim 2, wherein the m.SYN cookie includes ISN ₁₇, T₀ and Hash₁₃+ID_{fw}, ISN₁₇ being determined by upper 17 bits of the ISN of the SYN packet, T₀ being determined by least significant two bits of time indicated by the time counter of the firewall, which creates the m.SYN cookie, at the time of creation of the m.SYN cookie, Hash₁₃ being determined by the following Equation:
Hash₁₃=Hash(k, sa, sp, da, dp, time_{org}, ISN_{c}>>15)%2\hat{ }13
where Hash( ) is an output value of a hash function, k is a secret key, sa is a source address, sp is a source port number, da is a destination address, dp is a destination port number, ISN_{c}>>15 is a value obtained by eliminating lower 15 bits from ISN_{c}, Hash( )%2\hat{ }13 is a value of lower 13 bits of the output value of the hash function, time_{org} is time indicated by the time counter of the firewall wall, which creates the m.SYN cookie, at the time of creation of the m.SYN cookie

7. The method as set forth in claim 1, wherein step (b) is performed in such a way that the ISN of the SYN packet is replaced with the created m.SYN cookie, and the connection information including the difference between the ISN and the m.SYN cookie is stored in the state table of the firewall.

8. The method as set forth in claim 1, wherein step (c) further comprises the steps of:
(c1) extracting the ID_{fw} from the SYN/ACK packet;
(c2) verifying whether the extracted ID_{fw} is valid;
(c3) comparing the ID_{fw}, which is verified to be valid at step (c2), with an ID_{fw} of the firewall, which has received the SYN/ACK packet; and
(c4) if, as a result of the comparison at step (c3), the two ID_{fw}s are identical with each other, searching the state table of the firewall that has received the SYN/ACK packet and modifying the state table and the SYN/ACK packet, or if the ID_{fw}s are different from each other, sending the SYN/ACK packet to the firewall corresponding to the extracted ID_{fw}.

9. The method as set forth in claim 8, wherein step (c1) is performed in such a way that the m.SYN cookie included in the SYN/ACK packet is extracted, and the ID_{fw} is extracted from the m.SYN cookie using the following equations.
ID_{fw}=(SC−Hash(k, sa, sp, da, dp, timeᵢₙₚᵤₜ, SC>>15))%2\hat{ }13
where SC is the m.SYN cookie included in the SYN/ACK packet, Hash( ) is an output value of a hash function, k is a secret key, sa is a source address, sp is a source port number, da is a destination address, dp is a destination port number, timeᵢₙₚᵤₜ is time obtained using the following Equation, SC>>15 is a value obtained by eliminating lower 15 bits from the SC, and ( )%2\hat{ }13 is a value of lower 13 bits of the value of ( )
timeᵢₙₚᵤₜ=time_{curr}+1((time_{curr}+1−T₀)mod4)
where time_{curr} is the time indicated by the time counter of the firewall, which verifies the extracted m.SYN cookie, at the time of verification of the extracted m.SYN cookie, and T₀ is the least significant two bits of time indicated by the time counter of the firewall, which creates the m.SYN cookie, at the time of creation of the m.SYN cookie.

10. The method as set forth in claim 8, wherein step (c2) is performed in such a way as to compare the extracted ID_{fw} with a preset maximum ID_{fw}, and if the extracted ID_{fw} is not larger than the preset maximum ID_{fw}, verifying the extracted ID_{fw} to be valid, or if the extracted ID_{fw} is larger than the preset maximum ID_{fw}, verifying the extracted ID_{fw} to be invalid.
